(19) United States
(12) Patent Application Publication
(10) Pub. No.: US 2026/0168942 A1
(43) Pub. Date: Jun. 18, 2026

(54) SYSTEM AND METHOD FOR SYNCHRONIZING RADIOLOGIC EVENTS WITH NON-RADIOLOGIC IMAGES

(71) Applicant: See All AI Inc., Nashua, NH (US)

(72) Inventors: Todd Furlong, Nashua, NH (US); Robert Gilliam, Nashua, NH (US); Thomas Michael Thornton, Nashua, NH (US); Justin Faulk, Nashua, NH (US)

(73) Assignee: See All AI Inc., Nashua, NH (US)

(21) Appl. No.: 19/307,739

(22) Filed: Aug. 22, 2025

Related U.S. Application Data
(60) Provisional application No. 63/686,019, filed on Aug. 22, 2024.

(51) Int. Cl. G01N 23/046; G01N 23/04; H04N 23/60

(52) U.S. Cl. CPC G01N 23/046; G01N 23/043; H04N 23/64; G01N 2223/302

(57) ABSTRACT

A system and method for synchronizing radiologic events with non-radiologic images utilizes a radiation detection device responsive to the source of radiation, a surgical navigation camera for capturing non-radiologic images of a subject, and a correlation module configured to synchronize time stamps of at least one non-radiologic image with meta data representing the radiation event. In embodiments, the radiation event time stamp and the non-radiologic image time stamp are generated with a synchronized time base.

### FIELD OF INVENTION

The disclosure relates to the field of surgical navigation systems, and specifically a device for detecting radiation during surgical procedures.

### BACKGROUND

In modern surgical procedures, precise navigation and imaging are crucial for successful outcomes. Fluoroscopy, a technique that uses x-rays to obtain real-time moving images of the interior of the body, is commonly employed. However, this process often requires the patient to hold their breath to avoid motion artifacts, which can be challenging and may lead to complications. Current systems require that the patient hold their breath or the anesthetist use of a manual trigger (UI button, foot pedal, etc.) to coordinate the capture of pose with radiation detection. As such, current navigation systems lack the capability to integrate radiation detection with real-time pose tracking, making the process cumbersome and less accurate.

Accordingly, need exists for the ability to integrate radiation detection with real time pose tracking.

Further need exists for a radiation detection device for use with fluoroscopic imaging during surgeries.

A still further need exists for a radiation detection device for use in conjunction with surgical navigation cameras to accurately detect and track the pose of a patient during a radiation event.

Another need exist for a mechanism that allows for simultaneous capturing of both fluoroscopic images and visible light images at the same instant.

### SUMMARY OF THE INVENTION

The disclosed system facilitates pairing non-radiologic tracking data with radiologic images captured from an X-ray or fluoroscopy machine, e.g., a C-arm, as commonly needed for intraoperative registration of a patient's pre-op CT scan to a navigation or robotic system. Prior art solutions use a two-image capture that requires a breath hold to ensure that the patient does not move. Instead, in the disclosed system, a radiation detector is used as a trigger that allows the capture of non-radiologic navigation tracking data from a camera and with association radiologic images from the fluoroscope, without the need for the patient to hold their breath. Once fluoroscopic images are captured, they are paired with non-radiologic navigation tracking data, e.g. camera images, to enable better visualization of the surgical process.

The disclosed system addresses the prior art challenges by introducing a surgical navigation system that integrates a radiation detection device within a surgical navigation camera. The system leverages algorithms to enhance pose detection of both the patient and the fluoroscope when x-rays are triggered, allowing for precise tracking without requiring the anesthetist to manually direct the patient's breathing, thus improving surgical accuracy and patient safety.

According to one aspect of the disclosure, a method and non-transitory computer-readable medium for synchronizing radiologic events with non-radiologic images comprises: A) detecting with a sensor a radiation event having a predetermined level of radiation and generating a radiation event signal in response thereto; B) associating an event time stamp with metadata describing the radiation event upon receiving the radiation event signal; C) capturing a plurality of non-radiologic images of a subject with an image capture device, each of the plurality of non-radiologic images having a respective image time stamp associated therewith; and D) correlating with program logic the event time stamp with one of the plurality of image time stamps. In embodiments, D) comprises associating the event time stamp with one of the plurality of image time stamps having a closest time stamp value or associating the event time stamp with one of the plurality of image time stamps based on a sequential order of the plurality of image time stamps. In embodiments, the method further comprises: E) associating the metadata describing the radiation event with the non-radiologic image having an image time stamp correlated with the event time stamp. In embodiments, the radiation event comprises capturing a radiologic image of the subject with a radiologic imaging device. In embodiments, the event time stamp and the plurality of respective image time stamps are generated with a synchronized time base or with the same clock source. In embodiments, C) comprises capturing a plurality of visible light images of a subject with camera substantially simultaneously with receiving the radiation event signal or capturing a plurality of infrared images of a subject with camera substantially simultaneously with receiving the radiation event signal.

According to another aspect of the disclosure, a method and non-transitory computer-readable medium for synchronizing radiologic events with non-radiologic images comprises: A) detecting with a sensor a radiation event having a predetermined level of radiation and generating a radiation event signal in response thereto; B) associating, with program logic, an event time stamp with metadata describing the radiation event upon receiving the radiation event signal; and C) associating the metadata describing the radiation event with a non-radiologic image having an image time stamp correlated with the event time stamp, wherein the event time stamp and the image time stamp are generated with a synchronized time base. In embodiments, the method further comprises: D) capturing a plurality of non-radiologic images of a subject with an image capture device, each of the plurality of non-radiologic images having a respective image time stamp associated therewith. In embodiments, the D) comprises: D1) capturing a plurality of visible light images of a subject with camera substantially simultaneously with receiving the radiation event signal. In embodiments, the method further comprises E) correlating with program logic the event time stamp with one of the plurality of image time stamps. In embodiments, E) comprises associating the event time stamp with one of the plurality of image time stamps having a closest time stamp value or associating the event time stamp with one of the plurality of image time stamps based on a sequential order of the plurality of image time stamps. In embodiments, the radiation event comprises capturing a radiologic image of the subject with a radiologic imaging device.

According to still another aspect of the disclosure, a system for synchronizing radiologic events with non-radiologic images comprises: a sensor configured to generate a radiation event signal in response to detecting a level of radiation; a processing module responsive to the radiation event signal and configured to associate an event time stamp with metadata describing the radiation event upon receiving the radiation event signal, an image capture device configured for capturing a plurality of non-radiologic images of a subject, each of the plurality of non-radiologic images having a respective image time stamp associated therewith; and a correlation module, responsive to the processing module and respective image time stamps, configured for associating the metadata describing the radiation event with one of the plurality of non-radiologic images having an image time stamp correlated with the event time stamp. In embodiments, the system further comprises an image capture device configured for capturing a plurality of visible light images of a subject substantially simultaneously with receiving the radiation event signal or for capturing a plurality of infrared light images of a subject substantially simultaneously with receiving the radiation event signal. In embodiments, the event time stamp and the image time stamp are generated with a synchronized time base. In embodiments, the radiation event comprises capturing a radiologic image of the subject with a radiologic imaging device.

According to yet another aspect of the disclosure, a surgical navigation synchronizing system for use with an imaging system having a source of radiation and capable of generating radiologic images, comprises: a radiation detection device responsive to the source of radiation; a surgical navigation camera for capturing non-radiologic images of a subject, and a correlation module responsive to the radiation detection device and configured to synchronize at least one non-radiologic image with meta data representing the radiation event. In embodiments, the correlation module associates an event time stamp with one of the plurality of non-radiologic image time stamps having either a closest time stamp value or a sequential order of the plurality of image time stamps. In embodiments, the radiation event comprises capturing a radiologic image of the subject with a radiologic imaging device. In embodiments, the system further comprises an image capture device configured for capturing a plurality of visible light images of a subject substantially simultaneously receiving the radiation event signal or for capturing a plurality of infrared light images of a subject substantially simultaneously with receiving the radiation event signal. In embodiments, the event time stamp and the image time stamp are generated with a synchronized time base.

According to still yet another aspect of the disclosure, a surgical navigation system comprises: a radiation detection device, a surgical navigation camera, a processing module responsive to the radiation detection device and surgical navigation camera and configured to analyze images and radiation event data, respectively, to detect and track the pose of a patient and a fluoroscope; and a display interface responsive to the processing module for providing real-time visual feedback of the patient and fluoroscope positioning. In embodiments, the radiation detection device identifies x-ray emissions from a fluoroscope. In other embodiments, the processing module compensates for patient movement during x-ray fluoroscopy by recording the position of the patient when the fluoroscopic image is triggered. In other embodiments, the display interface shows near real-time position adjustments of surgical instruments or the patient.

According to even yet another aspect of the disclosure, a surgical navigation system for use with a radiation imaging machine, having a source of radiation and capable of generating radiologic images, comprises: a radiation detection device responsive to the source of radiation; a surgical navigation camera for generating non-radiologic images, and a processing engine responsive to the radiation detection device and configured to receive navigational images from the surgical navigation camera when the radiation detection device detects that the source of radiation is active and further configured to synchronize the at least one non-radiologic image with a corresponding radiologic image. The system may further comprise a display interface responsive to the processing unit for providing real-time visual feedback of the patient with one or both of the non-radiologic image and corresponding radiologic image. The at least one non-radiologic image and corresponding radiologic image may each have respective associated time stamps identifying a time value. In embodiments the processing engine synchronizes the at least one non-radiologic navigational image with a corresponding radiologic image according to an order of receipt from the respective surgical navigation camera and radiation imaging machine and not by the time values of their respective time stamps. In other embodiments, the processing engine is configured to synchronize multiple non-radiologic navigational images with multiple corresponding radiologic images according to an order of receipt from the respective surgical navigation camera and radiation imaging machine.

### DESCRIPTION OF THE DRAWINGS

The various features and advantages of the disclosure may be more readily understood with reference to the following detailed description taken in conjunction with the accompanying drawings, wherein like references designate like structural elements, and in which:

FIG. 1 illustrates conceptually a view of a surgical navigation system in accordance with the disclosure;

FIG. 2 illustrates conceptually a block diagram of a radiation detection circuit in accordance with the disclosure;

FIG. 3 is a flowchart of the method utilized by the navigation engine to coordinate tracking of the patient pose during image captured in accordance with the disclosure;

FIG. 4 is a flowchart of the method utilized by the navigation engine to coordinate tracking of the patient pose during image captured in accordance with the disclosure;

FIGS. 5A-B illustrate conceptually the synchronizing of radiologic events with non-radiologic images in accordance with the disclosure; and

FIG. 6 illustrates conceptually a block diagram of a surgical navigation system and processes for reconstructing a three-dimensional (3D) volume from a plurality of images synchronized with radiologic images in accordance with the disclosure.

### DETAILED DESCRIPTION

As used herein the terms “radiologic”, “radiographic” or “radiography” or variations thereof are intended to include both traditional X-ray technology and images and as well as fluoroscopy or fluoroscopic technology and images, as well as computed tomography (CT) technology and images.

### System Overview

Disclosed is a system and methods for synchronizing optical and radiographic data to enhance imaging capabilities. Specifically, the disclosed system and method synchronously combine both visually obtained patient pose position information and radiographic image information to facilitate calibrated surgical navigation. The process involves a data acquisition phase, a system calibration phase, a volume reconstruction phase, and a surgical navigation phase, all resulting in the alignment of instrument coordinates with the patient and reconstructed volume coordinates enabling tracking and navigation of surgical instruments within a reconstructed 3D volume of a patient anatomy, even when such anatomy is not exposed during a procedure. The system calibration phase is described in detail in U.S. Pat. No. 12,361,631. The data acquisition phase, volume reconstruction phase, and surgical navigation phase are described in detail in US Patent Application Publications US 2025/0186014-A1 and US 2025/0191297-A1.

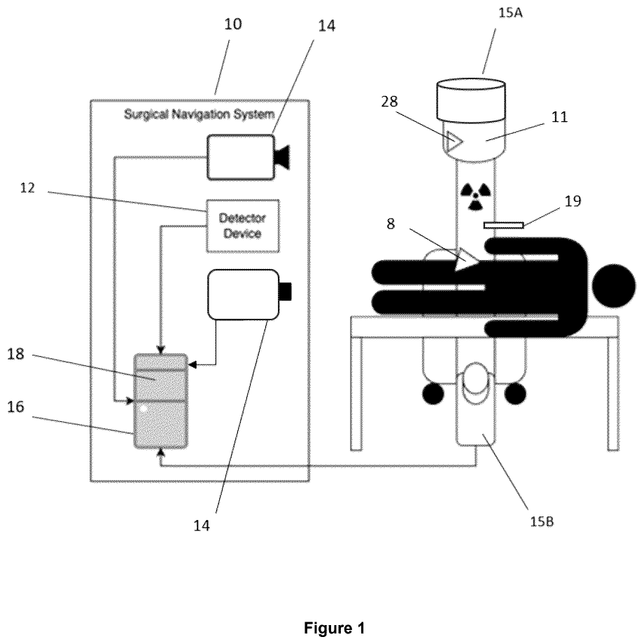

FIG. 1 illustrates conceptually a surgical navigation system 10 within a typical surgical procedure environment. As illustrated in FIG. 1, the surgical procedure space usually includes a surface on which the patient is disposed. A source of fluoroscopic radiation or x-rays is disposed beneath one side of the patient, as illustrated, while a detector of fluoroscopic radiation or x-rays is disposed on the opposite side of the patient. As explained in greater detail hereafter the surgical navigation system 10 utilizes a radiation detecting sensor, one or more visible light cameras and a processing engine to provide a near real-time display of positional images of the patient and any surgical tools on display as determined relative to a physical reference marker or object on the patients anatomy.

The surgical navigation system 10 may be used with a traditional fluoroscopy machine, e.g. a C-arm, having a source of radiation 15B disposed beneath the patient and a radiographic image detector 15A disposed on the opposite side of the patient. In embodiments, surgical navigation system 10 comprises reference markers 8 or 28, a radiation detector 12, a calibration target 11, cameras 14, computer 16, and a display interface 18. Computer 16 may be connected remotely from other components of system 10 but interoperable therewith through suitable network infrastructure. The surgical system 10, and particularly cameras 14, track the reference marker 8 or 28 within the camera coordinate system, e.g. the patient coordinate system, and forward the positional information of the reference markers onto computer 16 for further processing.

One or more external optical camera 14 may be positioned to capture the operating area, as illustrated, and detect optical reference marker 8 attached to the patient and the reference marker 28 attached to the calibration target 11. External optical camera 14 provides real-time tracking of the 6-DoF poses (rotation and translation) of the markers 8 and 28. In embodiments, camera 14 may be implemented using one or more visible light cameras to capture real-time images of the surgical field including the patient and X-ray imaging system, e.g. a fluoroscope. A camera suitable for use as camera 14 is the Polaris product line of optical navigation products, commercially available from Northern Digital, Waterloo, Ontario, Canada. External camera 14 may be in communication with one or both of radiation detector device 12 and a processing unit 16. When the imaging systems X-ray is triggered, synchronizing device 12 identifies X-ray emissions relative to a predefined threshold level and signals computer 16 and/or external camera 14 and to capture pose information of the patient and imaging system itself via reference markers 8 and 28, respectively.

Reference markers 8 and 28 are fiducial markers that are easily detectable by the optical camera 14 and are attached to the patient and the calibration target 11, respectively, and serve as points of reference for coordinate transformations. The implementation of reference markers 8 and 28 is set forth in greater detail in US Patent Application Publications US 2025/0186163-A1.

Calibration target 11, attachable to the radiographic image detector 15A, may be implemented with liner radiopaque markers embedded within the calibration target. The liner radiopaque markers have known 3D spatial coordinates relative to reference marker 8 attached to the calibration target 11. Such wires are visible in the captured radiographic images and are used for calibrating the radiographic imaging system, including intrinsic correction of non-linear distortions, as explained herein.

Surgical Instrument(s) 19 may be equipped with optical markers or tracked using object recognition and 3D localization algorithms, as described further herein, and allow for real-time tracking and alignment within a 3D volume of CT quality images reconstruct from two radiographic image, e.g. X-rays.

Display interface 18 is operably coupled to computer 16 and provides real-time visual feedback to the surgical team, showing the precise positioning and movement of the patient, imaging system itself, and any instruments. A display interface 18 suitable for use is the 13″ iPad Air, commercially available from Apple Computer, Inc. Cupertino, CA, USA, however, other commercially available surgical monitor may be used. As noted previously, the display interface may be located remotely from the computer 16 to facilitate more convenient positioning of the display interface 18 for the surgeon during the procedure.

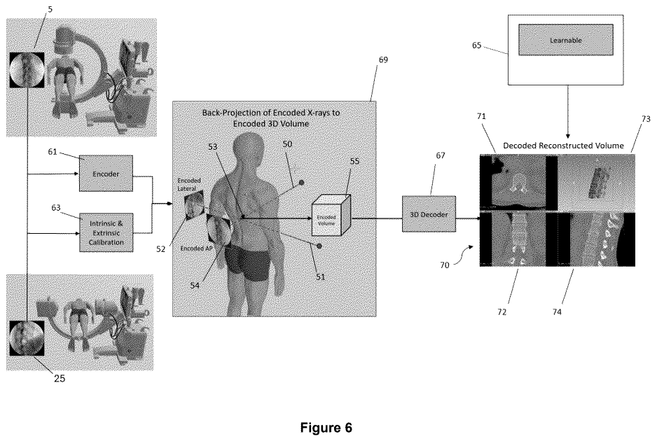

The proposed system 10 revolutionizes the reconstruction of 3D volumes from X-ray images by integrating machine learning or deep learning techniques, as further described with reference to FIG. 6. System 10 is specifically designed to effectively reconstruct complete and accurate 3D volumes using a limited number of X-ray images, even when these images are obtained from a restricted angular range.

### Radiation Detection Device

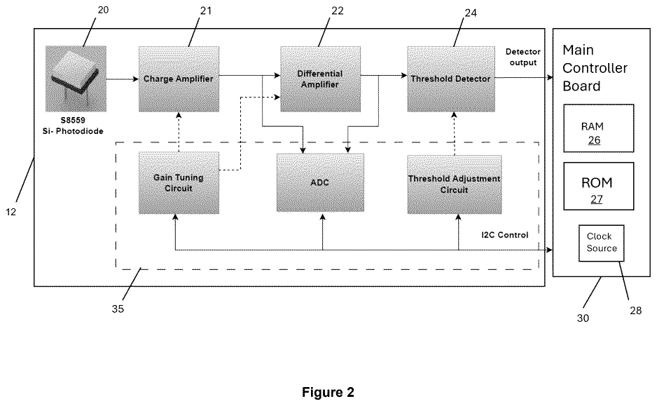

In embodiments, radiation detector 12 may be implemented using the circuitry illustrated in FIG. 2 for detecting the presence of radiation, typically fluoroscopic radiation, within the surgical procedure space. Device 12 detects x-rays emitted by the fluoroscope when a threshold is exceeded, typically measured in milliroentgens per hour (mR/h). In embodiments, the radiation detector 12 may be implemented with either a Geiger-Mueller tube or the combination of a scintillator and photodiode, either of which implementation produces a voltage or current depending on the amount of radiation incident thereon.

FIG. 2 illustrates conceptually a block diagram of an exemplary radiation detector device 12 with support circuitry in accordance with the disclosure. A scintillator and photodiode radiation detection circuit suitable for use with radiation detection device 12 is the Si photodiode (Model S8559), commercially available from Hamamatsu Corporation, Bridgewater, NJ 08807, which is a lower-voltage solution compared to a Geiger-Mueller tube sensor, illustrated as photodiode 20 in FIG. 2. Other radiation detector technologies may be similarly used for device 12. In embodiments, photodiode 20 is arranged in series with charge amplifier 21, differential amplifier 22 and threshold detector 24, as illustrated. Support circuitry 25, including a gain tuning circuit, analog to digital converter and threshold adjustment circuit interface with the various components in the photodiode threshold chain, as illustrated. In embodiments, the sampling rate of the analog to digital converter may be a multiple of the video frame rate of images generated by camera 14 to facilitate synchronization of radiation events and non-radiologic navigational images, as explained herein.

Threshold detector 24 generates a digital output signal, e.g., TTL-level GPIO, in response to a detected radiation pulse or x-ray exposure. In embodiments, GPIO (General-Purpose Input/Output) pins on a computer's mainboard or an add-on card may be used to send or receive electrical signals. Unlike standard ports like USB or HDMI, GPIO pins are not designed for any specific purpose, which is why they are termed “general-purpose.” The output of threshold detector 24 interfaces with main controller 30. In embodiments, the digital signal from threshold detector 24 is routed directly to a general-purpose input pin on the controller board 30 used in the system. The main controller 30 is responsible for orchestrating system-wide data acquisition, including video, tracking, and event timing. In embodiments, the main controller 30 runs a real-time thread or interrupt-driven routine that monitors the GPIO input pin for rising or falling edges. When a radiation event signal is detected, the system 10 immediately captures a high-resolution timestamp, typically in the microsecond range, depending on hardware capabilities. The timestamp is pushed to a software queue or event buffer for correlation with the time stamp of an acquired non-radiologic navigational image.

In embodiments, a Geiger tube detector and support circuitry may provide a GPIO signal when a high radiation event occurs. The Geiger tube detector may comprise of two major sections: a high voltage power supply for the Geiger tube and a digital logic counter/timer section. A power on reset keeps the DC-DC disabled for a brief time (˜200 mS), as well as resets the counter logic on power up.

The high voltage power supply may be a discrete boost DC-DC operating in discontinuous conduction mode, voltage doubler and comparator that acts as the regulator and shut off control. R1/C1 act as an astable multivibrator that supply the DC-DC with its switching frequency of approximately 50 kHz. The voltage from the DC-DC goes through a voltage doubler, whose output is divided down and fed back to a 2.5 v comparator which disables the DC-DC when the target threshold voltage is reached (with 1% hysteresis).

The regulated 500 VDC output goes through a large impedance to the Geiger tube. The voltage at the shell of the Geiger tube is watched by a comparator that triggers whenever the tube conducts. The input voltage of the LM 2903 is safe to operate above Vcc up to 36 v, and the circuit is tuned to provide ˜11 v peak, and trigger the comparator for ˜100 uS for each count detected.

A configurable expiration timer that starts every time a new radiation count is detected is utilized. The timer is configurable for either short (16.6 mS, or 1 video frame), or long (33.2 mS, or 2 video frames). A configurable counter counts each radiation count, and resets when the counter expires. Once the counter reaches the programmed threshold (N counts with less time than the programmed expiration timer between each count), the event starts. The event state is latched until no counts are received within the expiration timer length (each new count resets the timer). The last count can be detected by subtracting the timer time from when the GPIO goes low (16.6 mS or 33.2 mS). The count detected signal goes to a pulse extender that extends the pulse to 1.5 mS to drive the count LED for a visual indicator. All LED's can be disabled by removing the JP1 jumper.

The count detected signal also goes to a pulse extender that is programmed for the configurable expiration timer. When the pulse extender expires, the falling edge resets a counter circuit, which is counting down from a programmable count setting. Once the counter counts to N counts, the counter overflows, which latches the output of an overflow bit of the counter output, and stops the counter. When no more counts are received for the pulse extender time, the timer expires and the counter is reset, which resets the latch. All output signals are 5 v signals that are divided to 1.8 v logic levels, which also provides output impedance to protect the circuit from shorts.

### Cameras

In embodiments, surgical navigation camera 14 may be implemented using one or more visible light cameras to capture real-time images of the surgical field including the patient and the fluoroscope. A surgical navigation camera suitable for use as surgical navigation camera 14 is the Polaris product line of optical navigation products, commercially available from Northern Digital, Waterloo, Ontario, Canada.

In embodiment, the cameras 14 may be visible light cameras or infrared cameras capturing a stream of video images comprising video data frames, each frame having a time stamp associated therewith. In embodiment, other non-radiologic imaging technologies may be used to provide surgical navigational information including any of ultrasound, electromagnetic receiver/transmitter, or gyroscopic technologies, in place of or in addition to cameras for a stream of data frames each frame having a time stamp associated therewith. In embodiments, the sampling rate of the analog to digital converter of radiation detector device 12 may be a multiple of the video frame rate of images generated by camera 14 to facilitate synchronization of radiation events and non-radiologic navigational images, as explained herein.

### Synchronization Method

The method utilized by the surgical navigation system 10 in accordance with the disclosure is explained below. In the initial setup phase, the surgical navigation camera 14 along with integrated radiation detection device 12 are positioned in the operating room and aligned with the surgical field. Next, in the image acquisition phase, the camera 14 and detection device 12 capture images and radiation data, respectively. Surgical navigation camera 14 may be in communication with one or both of radiation detection device 12 and a processing unit 16. When the fluoroscope's x-ray is triggered, radiation detection device 12 identifies x-ray emissions relative to a defined threshold level and signals surgical navigation camera 14 and a processing unit 16 to capture pose information of the patient and fluoroscope. When the radiation detection device identifies that x-ray emission has ended, the processing engine 16 stops capturing pose information. In the pose detection phase, the algorithms in processing engine 16 process the captured data to accurately determine the pose of the patient and the fluoroscope by averaging the pose over the period of x-ray generation. Thereafter in the visual feedback phase, the display interface 14 shows the real-time position and movement of surgical instruments and patient, allowing the surgical team to make precise adjustments without requiring the anesthetist to control (or hold) the patient's breath.

Processor 16 utilizes program logic to associate non-radiologic navigation data images with fluoroscopic images. In embodiments, one or more non-radiologic navigation data images captured by surgical navigation camera 14 typically contain data defining multiple degrees of freedom, e.g. six degrees of freedom, of a pose of a patient or an object detected within a coordinate space. In embodiments, the radiologic image(s) may be two-dimensional fluoroscopic image captured by image detector section 15A of a fluoroscopy machine.

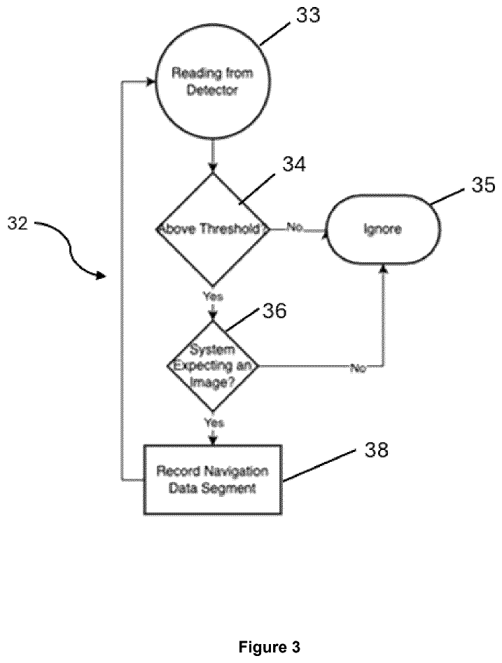

In embodiments, non-radiologic data image are always streaming from the surgical navigation camera 14 into the processor 16, and a user interface on display interface 18 may prompt the operator to take a specific image. As illustrated in FIG. 3, when the radiation reading is above a threshold and the system is expecting a radiologic image, recording of a navigation data image is performed, otherwise the non-radiologic navigation data image is ignored, as illustrated by blocks 33, 34 and 35. When the level of the radiation event signal is detected to be above a set threshold, as illustrated by decision block 34, one or more non-radiologic navigation data images from the camera 14 are recorded and time stamped, as illustrated by decision block 38.

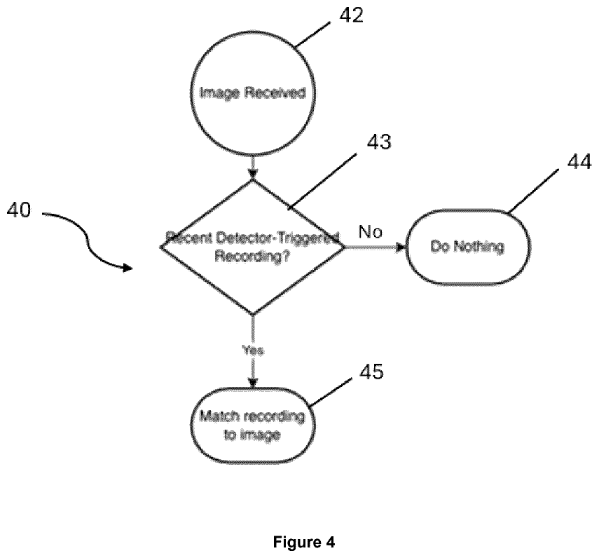

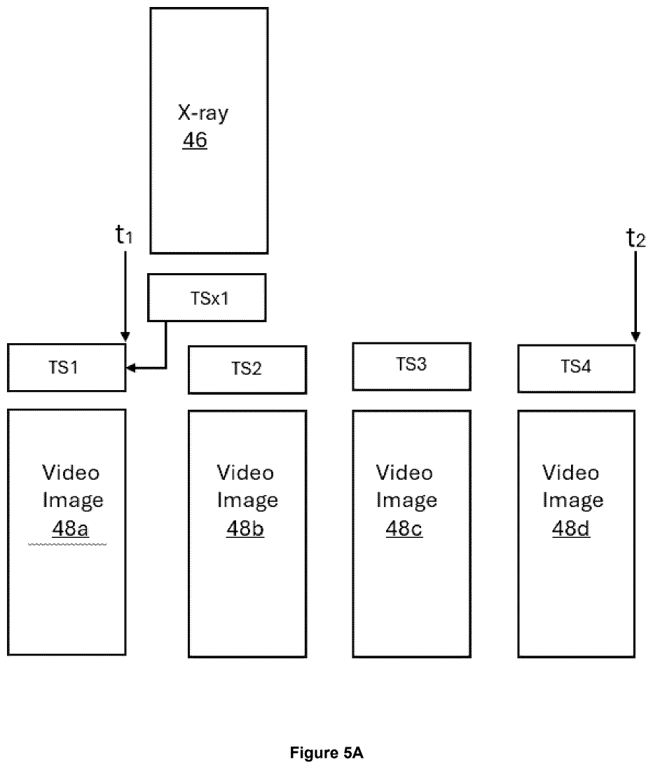

FIG. 4 is a flowchart of the method 40 for handling non-radiologic navigation data images from the camera 14. As illustrated in FIG. 4, non-radiologic navigation data images are continuously received from the camera 14 and stored in a buffer or queue but ignored unless radiation detection device 12 has indicated that a radiation event has occurred, as illustrated by blocks 42, 43 and 44. Otherwise, the radiologic images and non-radiologic navigation data images are assigned respective time stamps and their time stamps synchronized, as illustrated by decision block 46.

More specifically, with reference to FIGS. 2-4 and 5, the main controller board 30 executes a real-time thread or interrupt-driven routine, typically stored in RAM or ROM, that monitors the GPIO input pin for rising or falling edges of the radiation event signal from detector 12, as illustrated by block 33. If the radiation event signal from detector 12 is below a set threshold the signal is ignores, as illustrated by decision block 34 and block 35. When the level of the radiation event signal is detected to be above a set threshold, as illustrated by decision block 34, the main controller board 30 immediately captures a high-resolution timestamp, typically in the microsecond range, depending on hardware capabilities, and camera 14 begins recording of non-radiologic images, e.g. images 48a-b, as illustrated by block 38 and optional decision block 36. The timestamp TSx1 is pushed to a software queue or event buffer for association with simultaneously acquired radiologic X-ray image 46.

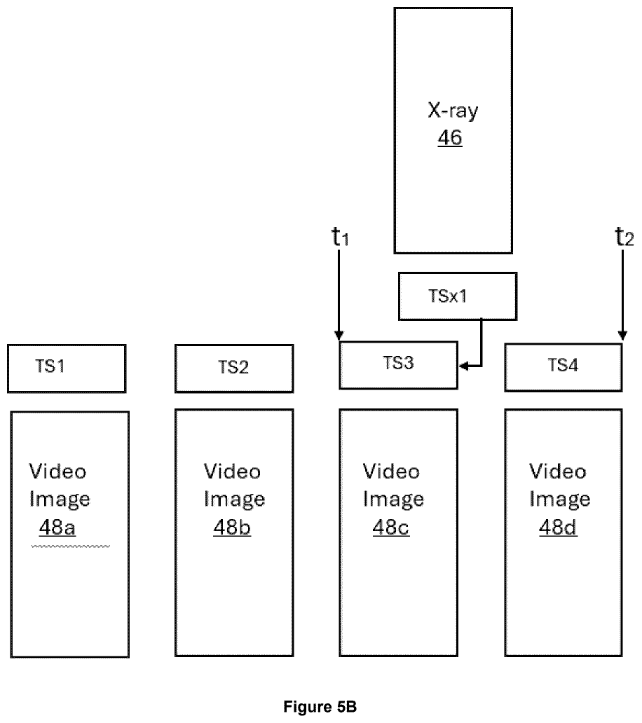

As illustrated in FIGS. 5A-B, navigation image frames 48a, 48b, 48c, 48d, . . . , as applicable, are captured by the imaging subsystem of system 10 and are timestamped with time stamps TS1, TS2, TS3, TS4, . . . , respectively, using the same system clock 28 or other synchronized time base, as used by the GPIO event stream. Following the detection of the radiation event signal at time t1, and assignment of a timestamp to the radiologic event, e.g. the capturing of an X-ray image, a matching or synchronization of radiologic images and non-radiologic navigation images is performed. In embodiments, to perform synchronization of non-radiologic images with non-radiologic images, processing logic on the main controller 30 associates radiation timestamps TSx1 of X-ray image 46 with the closest timestamped video frame 46a or 46b, or interpolates between adjacent video frames to match the exact time of the radiation event. Such correlation is used to tag video data with radiation event metadata, creating a tightly coupled record of both visual and radiological information.

In the exemplary illustration of FIG. 5A, the time stamp TSx1 and/or other assorted metadata of X-ray 46 is associated with or recorded into a metadata data structure associated with timestamp TS1 of video image 48a, as illustrated, since the TSx1 is temporally closest to the timestamp TS1, even though it was all or partially captured prior to the occurrence of a radiation event at time t1.

In the exemplary illustration of FIG. 5B, the time stamp TSx1 and/or other metadata of X-ray 46 is associated with or recorded into the metadata data structure associated with timestamp TS3 of video image 48c, as illustrated, since the TSx1 is temporally closest to the timestamp TS3 at occurrence of a radiation event at time t3.

In another embodiment, multiple radiologic images data sets and multiple non-radiologic navigation data images may be recorded before image data is sent to the processor 16. In this case, non-radiologic navigation image data sets are synchronized to radiologic images using the time stamps on the non-radiologic navigation image data sets. The spacing of the time stamps in the non-radiologic navigation data image metadata are aligned with spacing of the time stamps of the detected radiation events, e.g. the radiologic images. If the system receives the same quantity of non-radiologic navigation data images as recorded radiation exposure events, e.g. x-ray images, then the data may be sorted so that each timestamp from one of the non-radiologic navigation image data sets is the same offset from the associated time stamp from the corresponding non-radiologic image.

Other techniques for correlation of non-radiologic navigation data image detected radiation events may be used including averaging time stamp values of adjacent or multiple video frame time stamps to determine where the time stamp and/or metadata associated with a radiation event most accurately should be corelated with a stream of non-radiologic video images.

In embodiments, synchronization of correlation of radiologic images or events with non-radiologic images can be done without actual manipulation of the image files themselves, with the data representing the respective timestamps being maintained separately from the images with which they are associated.

FIG. 6 illustrates conceptually a process for automated reconstruction of a 3D CT volume from 2D X-ray images and display of real-time position and movement of surgical instruments and patient. Such systems and processes are described in U.S. Pat. No. 12,361,631 and US Patent Application Publications US 2025/0186014-A1 and US 2025/0191297-A1. Once the X-ray images are captured, computer executable instructions perform reconstruction of a 3D CT volume 70. The calibrated poses (Rᵢ, tᵢ) and intrinsic transform K are used to model X-ray projections using a generalized Radon transform, as further described in the above referenced US Patent and co-pending US Patent Applications. As illustrated in FIG. 5, a pair of radiographic images 5 and 25 are encoded and calibrated for intrinsic and extrinsic distortions, using modules 61 and 63, respectively. From the resulting pair of encoded radiographic images of 52 and 54, image projections are used to form basis vectors 50 and 51, and their intersection at a central point 53 used for generating the registration transform. The encoded radiographic images of 52 and 54 are back projected into an encoded volume 55 which is then decoded, using module 67, into a three-dimensional volume 70 capable of multiplanar views, including axial, sagittal, coronal, and 3D views of the three-dimensional volume. Back-projection and deep learning techniques may be used to reconstruct the 3D volume of CT quality images from the biplanar X-ray images 5 and 25. The three-dimensional volume 70, including any of specific views 71, 72, 73 or 74, may be generated with the assistance of deep learning module 65.

The reader will appreciate that the disclosed device and methods may enhance accuracy by providing precise pose detection of the patient relative to the fluoroscope during movement of the patient improving surgical outcomes. The disclosed device and methods may improve patient safety by eliminating the need for manual breath control of the patient, reducing risks for the patient. The disclosed device and methods may increase efficiency by streamlining the surgical process, thereby reducing the time and effort required for navigation.

The disclosed device and methods may be used in orthopedic surgeries to enhance the precision of bone alignments and implant placements. The disclosed device and methods may be further used in neurosurgeries to provide accurate navigation for delicate brain and spinal procedures. Even further, the disclosed device and methods may be used in cardiovascular surgeries to facilitate precise interventions in complex cardiac operations.

Although the systems and methods disclosed herein have been described with reference to patient anatomy and surgical navigation procedures, their applicability is not limited to the same. Any of the systems and methods disclosed herein may be utilized in other situations, including industrial control, package or baggage handling, or any other environments in which the near real-time position and tracking of objects within a volume is required.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

At various places in the present specification, values are disclosed in groups or in ranges. It is specifically intended that the description includes each and every individual sub-combination of the members of such groups and ranges and any combination of the various endpoints of such groups or ranges. For example, an integer in the range of 0 to 40 is specifically intended to individually disclose 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40, and an integer in the range of 1 to 20 is specifically intended to individually disclose 1, 2, 3, 4, 5, 6, 7, 8, 9, 10, 11, 12, 13, 14, 15, 16, 17, 18, 19, and 20.

To the extent that the term “includes” or “including” is employed in the detailed description or the claims, it is intended to be inclusive in a manner similar to the term “comprising” as that term is interpreted when employed as a transitional word in a claim.

Throughout this specification and the claims that follow, unless the context requires otherwise, the words ‘comprise’ and ‘include’ and variations such as ‘comprising’ and ‘including’ will be understood to be terms of inclusion and not exclusion. For example, when such terms are used to refer to a stated integer or group of integers, such terms do not imply the exclusion of any other integer or group of integers.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

For purposes of clarity and a concise description, features are described herein as part of the same or separate embodiments, however, it will be appreciated that scope of the concepts may include embodiments having combinations of all or some of the features described herein. Further, terms such as “first,” “second,” “top,” “bottom,” “front,” “rear,” “side,” and other are used for reference purposes only and are not meany to be limiting.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to an example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first.” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

While example systems, methods, and other embodiments have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and other embodiments described herein. Therefore, the invention is not limited to the specific details, the representative apparatus, and illustrative examples shown and described. Thus, this application is intended to embrace alterations, modifications, and variations that fall within the scope of the appended claims.

1. A method for synchronizing radiologic events with non-radiologic images, the method comprising:
A) detecting with a sensor a radiation event having a predetermined level of radiation and generating a radiation event signal in response thereto;
B) associating an event time stamp with metadata describing the radiation event upon receiving the radiation event signal;
C) capturing a plurality of non-radiologic images of a subject with an image capture device substantially simultaneously with receiving the radiation event signal, each of the plurality of non-radiologic images having a respective image time stamp associated therewith; and
D) correlating with program logic the event time stamp with one of the plurality of image time stamps.

2. The method of claim 1 wherein D) comprises:
D1) associating the event time stamp with one of the plurality of image time stamps having a closest time stamp value.

3. The method of claim 1 wherein D) comprises:
D1) associating the event time stamp with one of the plurality of image time stamps based on a sequential order of the plurality of image time stamps.

4. The method of claim 1 further comprising:
E) associating the metadata describing the radiation event with the non-radiologic image having an image time stamp correlated with the event time stamp.

5. The method of claim 1 wherein the radiation event comprises capturing a radiologic image of the subject with a radiologic imaging device.

6. The method of claim 1 wherein the event time stamp and the plurality of respective image time stamps are generated with a synchronized time base.

7. The method of claim 6 wherein the event time stamp and the plurality of respective image time stamps are generated with a same clock source.

8. The method of claim 1 wherein C) comprises:
C1) capturing a plurality of visible light images of a subject with camera substantially simultaneously with receiving the radiation event signal.

9. The method of claim 1 wherein C) comprises:
C1) capturing a plurality of infrared images of a subject with camera substantially simultaneously with receiving the radiation event signal.

10. A method for synchronizing radiologic events with non-radiologic images, the method comprising:
A) detecting with a sensor a radiation event having a predetermined level of radiation and generating a radiation event signal in response thereto;
B) associating an event time stamp with metadata describing the radiation event upon receiving the radiation event signal by program logic; and
C) associating the metadata describing the radiation event with a non-radiologic image having an image time stamp correlated with the event time stamp,
wherein the event time stamp and the image time stamp are generated with a synchronized time base.

11. The method of claim 10 further comprising:
D) capturing a plurality of non-radiologic images of a subject with an image capture device substantially simultaneously with receiving the radiation event signal, each of the plurality of non-radiologic images having a respective image time stamp associated therewith.

12. The method of claim 11 further comprising:
E) correlating with program logic the event time stamp with one of the plurality of image time stamps.

13. The method of claim 12 wherein D) comprises:
E1) associating the event time stamp with one of the plurality of image time stamps having a closest time stamp value.

14. The method of claim 12 wherein D) comprises:
E1) associating the event time stamp with one of the plurality of image time stamps based on a sequential order of the plurality of image time stamps.

15. The method of claim 10 wherein the radiation event comprises capturing a radiologic image of the subject with a radiologic imaging device.

16. The method of claim 11 wherein D) comprises:
D1) capturing a plurality of visible light images of a subject with camera substantially simultaneously with receiving the radiation event signal.

17. A system for synchronizing radiologic events with non-radiologic images, the system comprising:
a sensor configured to generate a radiation event signal in response to detecting a level of radiation;
a processing module responsive to the radiation event signal and configured to associate an event time stamp with metadata describing the radiation event upon receiving the radiation event signal,
an image capture device configured for capturing a plurality of non-radiologic images of a subject, each of the plurality of non-radiologic images having a respective image time stamp associated therewith; and
a correlation module, responsive to the processing module and respective image time stamps, configured to associating the metadata describing the radiation event with one of the plurality of non-radiologic images having an image time stamp correlated with the event time stamp.

19-46. (canceled)

47. The system of claim 17 wherein the correlation module associates the event time stamp with one of the plurality of image time stamps having a closest time stamp value.

48. The system of claim 17 wherein the correlation module associates the event time stamp with one of the plurality of image time stamps based on a sequential order of the plurality of image time stamps.

49. The system of claim 17 wherein the radiation event comprises capturing a radiologic image of the subject with a radiologic imaging device.

50. The system of claim 17 wherein the image capture device is configured for capturing a plurality of visible light images of a subject substantially simultaneously with receiving the radiation event signal.

51. The system of claim 17 wherein the image capture device is configured for capturing a plurality of infrared light images of a subject substantially simultaneously with receiving the radiation event signal.

52. A surgical navigation synchronizing system for use with an imaging system having a source of radiation and capable of generating radiologic images, the synchronizing system comprising:
a radiation detection device responsive to a source of radiation;
a surgical navigation camera for capturing non-radiologic images of a subject, and
a correlation module responsive to the radiation detection device and configured to receive at least non-radiologic image from the surgical navigation camera when the radiation detection device detects that the source of radiation is active and further configured to synchronize the at least one non-radiologic image with meta data representing the radiation event.

53. The system of claim 24 wherein the correlation module associates an event time stamp with one of the plurality of image time stamps having a closest time stamp value.

54. The system of claim 24 wherein the correlation module associates the event time stamp with one of the plurality of image time stamps based on a sequential order of the plurality of image time stamps.

55. The system of claim 24 wherein the radiation event comprises capturing a radiologic image of the subject with a radiologic imaging device.

56. The system of claim 24 further comprising an image capture device configured for capturing a plurality of visible light images of a subject substantially simultaneously with receiving the radiation event signal.

57. The system of claim 24 further comprising an image capture device configured for capturing a plurality of infrared light images of a subject substantially simultaneously with receiving the radiation event signal.

58. The system of claim 24 wherein the event time stamp and the image time stamp are generated with a synchronized time base.
